(19) United States
(12) Patent Application Publication
(10) Pub. No.: US 2004/0098834 A1
(43) Pub. Date: May 27, 2004

(54) Hinge for a mobile phone

(75) Inventors: Sheng-Nan Lu, Shulin City (TW); Hsiang-Chi Chien, Shulin City (TW)

Correspondence Address: Jackson Walker L.L.P., Suite 2100, 112 E. Pecan Street, San Antonio, TX, 78205, US

(73) Assignee: Shin Zu Shing Co., Ltd.

(21) Appl. No.: 10/305,668

(22) Filed: Nov. 27, 2002

(51) Int. Cl. E05D 11/08

(52) U.S. Cl. 16/337

(57) ABSTRACT

A hinge for a mobile phone is composed of a barrel, a positioning member, a pintle, and a resilient ring. The barrel is installed in a cover of the mobile phone, and the pintle is installed in the body of the mobile phone and received in the barrel. The positioning member is secured in the barrel, and has two arms respectively abutting two flat surfaces of the pintle. The resilient ring is provided outside the arms to tightly position the pintle between the arms. When the cover is pivoted about the body upwards or downwards to a certain position, under the force of the resilient ring and the arms, the barrel can be automatically and rapidly pivoted further to raise or close the cover.

### BACKGROUND OF THE INVENTION

1. Field of the Invention

The present invention is related to a mobile phone, and more particularly to a hinge for a mobile phone by which a cover can be pivotally mounted on a body of the mobile phone.

2. Description of Related Art

Some mobile phones have a cover pivotally mounted on a body by a hinge, wherein the cover has an LCD monitor installed therein, and the body has a keyboard installed therein.

However, the cover mounted on the body by some conventional hinges cannot automatically open or close, so that a user must continuously turn the cover until the cover is completely raised or abuts the body, which is very inconvenient. In other conventional hinges, resilient members are provided to give the cover a function to automatically open or close. However, the resilient members usually are compressed in the closed status or the open status and will lose elasticity after a short-term time.

Therefore, the invention provides a hinge to mitigate and/or obviate the aforementioned problems.

### SUMMARY OF THE INVENTION

The main objective of the invention is to provide a hinge for a mobile phone by which a cover can automatically pivot about a body of the mobile phone.

Another objective of the invention is to provide a hinge for a mobile phone that can be used in a long-term time.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge for a mobile phone in accordance with the invention;

FIG. 2 is a sectional front view of the hinge in FIG. 1;

FIG. 3 is a sectional side view of the hinge in FIG. 2;

FIG. 4 is a perspective view of a mobile phone assembled with the hinge;

FIG. 5 is a sectional front view of the hinge in a pivoting status; and

FIG. 6 is a sectional side view of FIG. 5.

### DETAILED DESCRIPTION OF THE PREFERRED EMBODIMENT

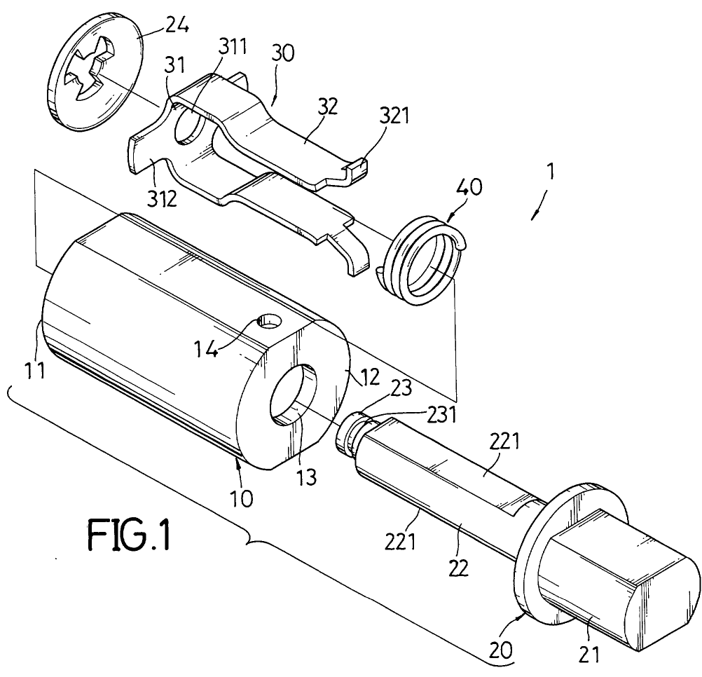

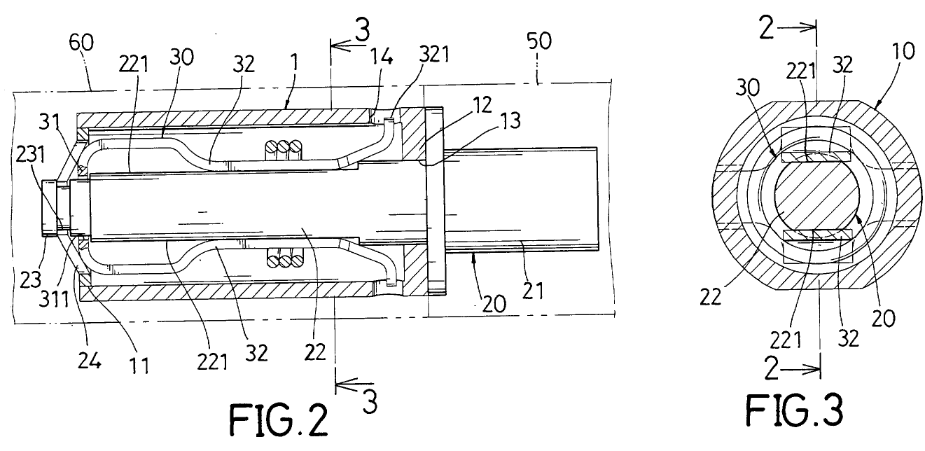

Referring to FIGS. 1-3, a hinge (1) for a mobile phone in accordance with the present invention is composed of a barrel (10), a pintle (20), positioning member (30), and resilient ring (40).

The barrel (10) has a first end (11) and a second end (12). A central hole (13) is defined through the second end (12), and two apertures (14) are diametrically oppositely defined at an outer periphery of the barrel (10) and adjacent the second end (12).

The pintle (20) has a first part (21), a second part (22), and a third part (23). A flange (not numbered) is formed between the first part (21) and the second part (22). The second part (22) has two flat surfaces (221) respectively formed at two diametrically opposite sides thereof. The second part (22) is pivotally received in the barrel (10) from the central hole (13) of the second end (12), and the third part (23) extends out from the first end (11) of the barrel (10). A recess (231) is circumferentially defined at an outer periphery of the third part (23). A dished collar (24) is installed in the recess (231) to fasten the pintle (20) in the barrel (10) with the flange abutting the second end (12) of the barrel (10).

The positioning member (30) has a sheet (31), and two arms (32) parallel to each other and perpendicular to the sheet (31). The sheet (31) has an opening (311) defined therethrough and two wings (312) transversally extending outwards. The barrel (10) further has two cutouts (not shown or numbered) defined in an inner wall thereof adjacent the first end (11), and the wings (312) are respectively received in the cutouts to secure the positioning member (30) in the barrel (10). The arms (32) each have a finger (321) formed at a distal end thereof and located in the respective aperture (14) to further secure the positioning member (30) in the barrel (10).

The third part (23) of the pintle (20) extends through the opening (311), and the second part (22) of the pintle (20) is located between the arms (32). The arms (32) respectively abut the flat surfaces (221) of second part (22) to position the pintle (20) in the barrel (10). The dished collar (24) is provided outside the sheet (31).

The resilient ring (40) is provided outside the arms (32) to further tightly position the pintle (20). The resilient ring (40) can be made as a helical spring.

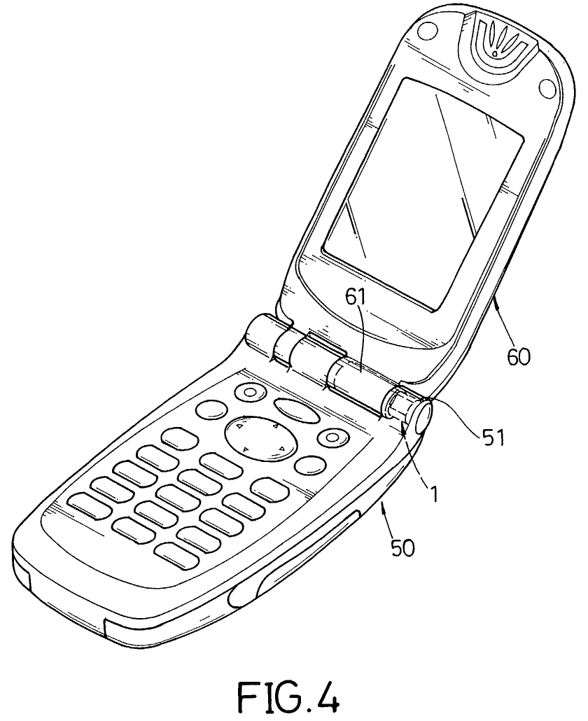

Referring to FIG. 4, a mobile phone has a body (50) and a cover (60). The first part (21) of the pintle (20) is secured in a first joint (51) to install the pintle (10) on the body (50), and the barrel (10) is installed in a second joint (61) of the cover (60).

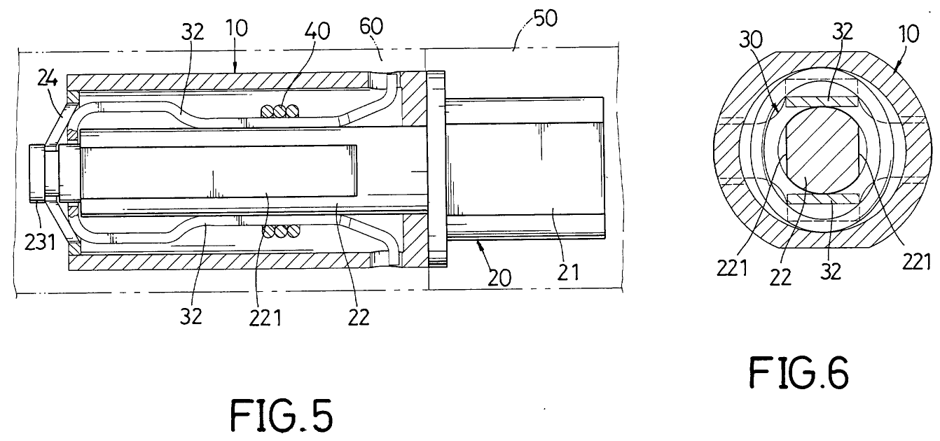

When the cover (60) abuts the body (50), the arms (32) of the positioning member (30) abut the flat surfaces (221) to position the pintle (20) in the barrel (10). Referring to FIGS. 5 and 6, when the user raises the cover (60), the barrel (10) along with the positioning member (30) is pivoted about the pintle (20), and the flat surfaces (221) are disengaged from the arms (32). The circumferential surfaces of the second part (22) between the flat surfaces (221) respectively abut the arms (32), and a distance between the arms (32) and an inner diameter of the resilient ring (40) is increased. Under the resilient force of the arms (32) and the resilient ring (40), the barrel (10) cannot stably stop at the circumferential surfaces without an external force from the user, and has a tendency to further rotate until the arms (32) respectively abut the flat surfaces (221) opposite to the original ones. Then, the cover (60) is opened and positioned.

A closing process to pivot downwards the cover (60) is similar to the process as hereinbefore, and will not be described in detail.

Therefore, according to the present invention, when the user pivots the cover (60) to a certain position, under the force of the resilient ring (40) and the arms (32), the barrel (10) can be automatically and rapidly pivoted further to raise or close the cover (60). Furthermore, at the open or closed position, the arms (32) abutting the flat surfaces (221) are of the original configuration without deformation, so that the hinge can be used effectively over a long-term.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge (1) for a mobile phone, the mobile phone having a body (50) and a cover (60), the hinge comprising;
a barrel (10) secured in the cover (60) of the mobile phone, the barrel (10) having a first end (11), a second end (12), and a central hole (13) defined through the second end (12);
a positioning member (30) installed in the barrel (10), the positioning member (30) having a sheet (31) secured at the first end (11) of the barrel (10), and two arms (32) parallel to each other and perpendicular to the sheet (31);
a pintle (20) rotatably mounted in the barrel (10), the pintle (20) having a first part (21) secured in the body (50) of the mobile phone, a second part (22) received in the barrel (10) through the central hole (13), and two flat surfaces (221) diametrically oppositely formed at an outer periphery of the second part (22) and respectively abutting the arms (32); and
a resilient ring (40) provided outside the arms (32) of the positioning member (30) and the second part (22) of the pintle (20).

2. The hinge as claimed in claim 1, wherein the positioning member (30) further has an opening (311) defined through the sheet (31), and the pintle (20) has a third part (23) extending through the opening (311), a recess (231) circumferentially defined at an outer periphery of the third part (23), and a dished collar (24) installed in the recess (231) to fasten the pintle (20) in the barrel (10).

3. The hinge as claimed in claim 1, wherein the barrel (10) further has two apertures (14) defined through an outer periphery adjacent the second end (12), and the positioning member (30) has two fingers (321) respectively formed at distal ends of the arms (32) and received in the apertures (14).

4. The hinge as claimed in claim 1, wherein the barrel (10) has two cutouts defined in an inner wall thereof, and the sheet (31) has two wings (312) transversally extending outwards and respectively received in the cutouts for securing the positioning member (30) in the barrel (10).
